(19) United States
(12) Patent Application Publication
(10) Pub. No.: US 2003/0139964 A1
(43) Pub. Date: Jul. 24, 2003

(54) Method for the interactive optimization of product properties

(76) Inventors: Reinier Kortekaas, Erlangen (DE); Patrick Mergell, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 10/348,543

(22) Filed: Jan. 21, 2003

(30) Foreign Application Priority Data
Jan. 21, 2002 (DE) 10202093.0

(51) Int. Cl. G06F 17/60

(52) U.S. Cl. 705/10

(57) ABSTRACT

A method and appertaining apparatus are provided for optimizing the design of product properties by surveying customers via the Internet and that their reply be automatically evaluated and incorporated into the product design. The potential customers can be divided intocategories according to their interests profiles, so that specific categories of customers can be surveyed in targeted fashion via the Internet.

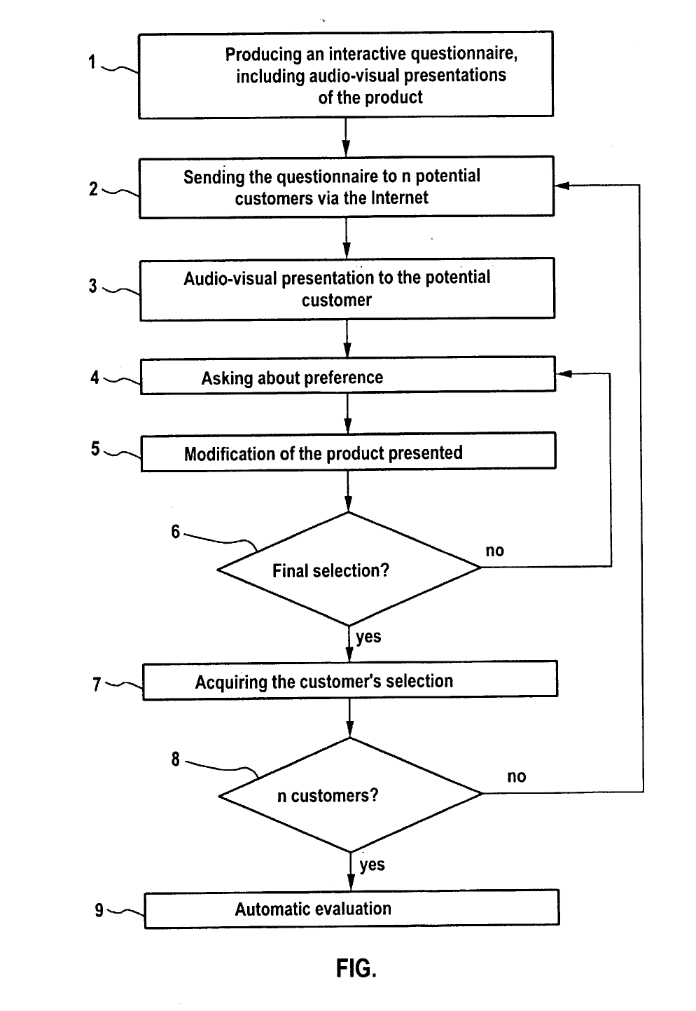

### BACKGROUND OF THE INVENTION

1. Field of the Invention

The present invention is directed to an apparatus and to a method for optimizing properties of a product by surveying a plurality or predetermined potential customers and evaluating the results of the survey for initiating optimization steps. In particular, the present invention is directed to the optimization of audio-visual product properties.

2. Description of the Related Art

There is often a need to design products for a great number of purchasers that are aesthetically appealing or pleasant to handle. When appropriate empirical data are unavailable, one is usually dependent on surveying the ultimate consumers in order to determine what constitutes a positive overall aesthetic effect and better handling ease; the ultimate design can then be based on these determinations. The customer preferences with respect to audio-visual product properties are usually determined via market research institutions. Over and above this, surveys of focus groups are standard in order, for example, to investigate user interfaces in terms of their handling. Such surveys, however, are comparatively expensive and involved.

### SUMMARY OF THE INVENTION

The object of the present invention is to be able to optimize the aesthetic properties of a product more simply and cost-beneficially.

This object is inventively achieved by a method for optimizing properties of a product by surveying a plurality of predetermined potential customers and evaluating the results of the survey for initiating optimization steps, where the potential customers are Internet users and the survey ensues on the basis of the Internet.

Furthermore, the above object is inventively achieved by an apparatus for optimizing properties of a product comprising a survey mechanism for surveying a plurality of predetermined potential customers and an evaluator for evaluating the results of surveys for initiating optimization steps, where the survey mechanism and evaluator comprise an Internet interface for canvassing the potential customers via the Internet.

Advantageous developments of the method include having the survey implementation send an electronic message to the potential customers by a mechanism that includes e-mail and Short Message Service. The survey may ensue interactively and may use interactive questionnaires. The surveying may provide a visual or audio-visual presentation to the potential customers via the Internet. The method may permit interactive modification of the product via the Internet, and may further utilize the Internet to permit the selection of alternatives. This process may continue iteratively until some particular termination criteria is met. The method may also collect interest profiles of a pool of potential customers, and these profiles may be used to categorize and implement the survey. Some form of reward may be given to customers after the survey.

When the product is a hearing aid, the method may comprise providing a user a choice for a control format; receiving a user selection for the choice for a control format; and presenting the users selection to the user in an audio-visual manner. The method may also include providing a user a choice for an option selected from the group consisting of shape, batter service life, size, weight, configurability, programmability features, and operating features as well as other options.

Advantageous developments of the apparatus may be configured to permit interactive surveying of potential customers, as well as implementing visual or audio-visual presentations, such as with the use of a video processing unit.

The invention thus enables an Internet-based optimization of product properties via the final consumer. The particular advantage is that Internet users are very numerous and can be assigned to a maximum variety of target groups. Arbitrary questions with respect to product properties that can be reproduced in versatile and multi-media fashion via the Internet can be flexibly tracked using interactive questionnaires. The type of survey and the form of evaluation can be directly monitored and specified by the manufacturer. Furthermore, there are no time restrictions for the test participants. Finally, the organizational outlay for the implementation of such an Internet survey is negligible in view of rewarding test subjects, for example, with e-cash, and in view of schedule planning as well as office space requirements.

### DESCRIPTION OF THE DRAWING

The present invention is explained below in greater detail on the basis of the attached drawing, which shows a schematic flowchart of the inventive method.

### DETAILED DESCRIPTION OF THE INVENTION

The exemplary embodiments described below represent preferred embodiments of the invention.

According to the exemplary embodiment shown in the drawing, the inventive method begins in step 1 with the production of an interactive questionnaire, including a plurality of audio-visual presentations or a plurality of alternatives of the product. In a second step, the manufacturer sends the interactive questionnaire to n potential customers via the Internet. According to step 3, the customer can call the audio-visual presentation and, according to step 4, is asked about respective preferences or categories. When the customer indicates a specific preference or category, then the illustrated product is modified in step 5 according to the preference of the customer. The questioning about preferences and the modification of the illustrated product in steps 4 and 5 is repeated until the customer has made his/her final selection according to step 6. The final selection of the customer is subsequently acquired according to step 7. This individual selection is implemented for an arbitrary plurality of n customers, so that n customer surveys are ultimately present. An automatic evaluation on the basis of these n customer surveys is implemented according to step 9 and the product can, for example, be given its final form on this basis.

A specific example for the application of this method would be the determination of the number of operating elements for setting a hearing aid amplification. First, the potential customer is audio-visually presented with a plurality of property alternatives (A, B, etc.). For example, the customer is asked whether he/she prefers an adjustment wheel or a graduated button switch. When an adjustment wheel is preferred, then this is audio-visually presented. This process can be similarly continued for other properties of the hearing aid, for example, shape, battery service life, etc., up to some predetermined endpoint. A plurality of messages of potential customers about the product to be designed can thus be automatically acquired and evaluated.

An alternative method of execution is to have Internet users log on at the manufacturer or surveying institute as “product testers” upon, for example, providing an e-mail address and specific areas of interest. The product testers may be selected for specific products from a pool and on the basis of their interests profiles and may be requested to vote via e-mail. The circle of product testers can be controlled by this in a targeted fashion by the manufacturer. As a reward for a usable answerback, the product tester can receive a reward, such as e-cash of “payback points”.

The inventive survey system is particularly suited in view of designing software user interfaces, car design, etc., when questions of taste or aesthetics as well as questions of handling are prominent.

For the purposes of promoting an understanding of the principles of the invention, reference has been made to the preferred embodiments illustrated in the drawing, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Use of the word “mechanism” is not intended to be limited to a physical mechanism, but could include non-physical elements as well. Numerous modifications and adaptations will be readily apparent to those skilled in this art without departing from the spirit and scope of the present invention.

What is claimed is:

1. A method for optimizing properties of a product, comprising:
surveying, via the Internet, a plurality of predetermined potential customers who are Internet users; and
evaluating the results of the survey for initiating optimization steps.

2. The method according to claim 1, wherein the surveying comprises sending an electronic message to the potential customers by a mechanism that includes e-mail and Short Message Service.

3. The method according to claim 1, wherein the surveying ensues interactively, utilizing interactive questionnaires.

4. The method according to claim 1, wherein the surveying comprises providing a visual or audio-visual presentation to the potential customers via the Internet.

5. The method according to claim 1, further comprising:
interactively modifying the product via the Internet.

6. The method according to claim 1, further comprising:
selecting alternatives of the product via the Internet

7. The method according to claim 1, further comprising, in an iterative manner until a termination criteria is met:
providing a visual or audio-visual presentation to the potential customers via the Internet;
interactively modifying the product via the Internet; and
selecting alternatives of the product via the Internet.

8. The method according to claim 1, further comprising:
collecting interest profiles of a pool of potential customers;
dividing the pool of potential customers into categories based on the interest profiles before the survey and the survey ensues specifically based on the respective category.

9. The method according to claim 1, further comprising:
rewarding potential customers after the survey.

10. The method according to claim 1, wherein the product is a hearing aid, further comprising:
providing a user a choice for a control format;
receiving a user selection for the choice for a control format; and
presenting the users selection to the user in an audio-visual manner.

11. The method according to claim 10, further comprising:
providing a user a choice for-an option selected from the group consisting of shape, batter service life, size, weight, configurability, programmability features, and operating features.

12. An apparatus for optimizing properties of a product, comprising:
a survey mechanism configured to survey a plurality of predetermined potential customers, the survey mechanism comprising an Internet interface configured to survey the predetermined potential customers via the Internet; and
an evaluator configured for evaluating results of surveys for initiating optimization steps, the evaluator comprising an Internet interface configured to evaluate potential customer input via the Internet.

13. The apparatus according to claim 12, wherein the survey mechanism is configured for interactive surveying of potential customers.

14. The apparatus according to claim 12, wherein the survey mechanism is configured to implement visual or audio-visual presentations.

15. The apparatus according to claim 14, wherein the survey mechanism comprises a video processing unit.
